(19) United States
(12) Patent Application Publication
(10) Pub. No.: US 2005/0217404 A1
(43) Pub. Date: Oct. 6, 2005

(54) Selector apparatus of an automatic transmission of vehicle

(76) Inventors: Takayuki Suzuki, Shizuoka-ken (JP); Shigeaki Oda, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 11/090,869

(22) Filed: Mar. 25, 2005

(30) Foreign Application Priority Data
Mar. 25, 2004 (JP) 2004-089722

(51) Int. Cl. F16H 35/18

(52) U.S. Cl. 74/473.12

(57) ABSTRACT

A vehicle automatic transmission selector apparatus which can suppress increased teeth backlash of a gear arrangement of a lever bracket and a select-link to improve operability of the selector lever has brackets (1a) and (1b) to be secured on a body of a vehicle. A selector lever (2) is pivotally supported on the brackets (1a) and (1b). A lever bracket (3) is arranged at a base end of the selector lever (2) and formed with sector gear teeth (3a). A selector-link (4), for actuating a transmission via a wire (W) interposed between the selector-link (4) and the transmission, is formed with sector gear teeth (4a). The teeth 4a mate with the sector gear teeth (3a) of the lever bracket (3). The selector-link (4) is rotated by the pivotal motion of the selector lever (2). An urging mechanism (7) and (8) urges the select-link (4) toward the lever bracket (3) so that the teeth (4a) of the select-link (4) are brought close to the teeth (3a) of the lever bracket (3).

### CROSS-REFERENCE TO RELATED APPLICATION

This application claims priority to Japanese Patent Application No. 2004-089722, filed Mar. 25, 2004, which application is herein expressly incorporated by reference.

### FIELD OF THE INVENTION

The present invention relates to a shift selector for vehicle automatic transmissions to carry out the shifting operation of the transmission by transmitting the pivotal motion of the selector lever to a select-link, via a gear arrangement.

### BACKGROUND OF THE INVENTION

In general, a selector apparatus has a selector lever operated by a driver provided on a vehicle with an automatic transmission. The selector lever can be pivotally moved, for example, to a parking position (P), a reverse position (R), a neutral position (N) and a drive position (D). The base end of the selector lever includes a lever bracket which has an aperture for the pivotal shaft of the selector lever and is connected to the automatic transmission via a push-pull wire.

Various structures of selector apparatus have been required to be adapted to the many vehicle interior layout limitations in order to satisfy desires of the users. Accordingly, in Japanese Laid-open Patent Publication No. 315070/1995, a selector apparatus is proposed with a gear arrangement to correspond to the shifting direction of the selector lever and the moving direction of the push-pull wire.

In the selector apparatus of the prior art, a lever bracket is formed with teeth of a sector gear. Also, a select-link is provided with a sector gear having teeth mating with the lever bracket sector gear. The select-link is pivotally mounted on a bracket similar to the selector lever and is connected to an automatic transmission by an extending push-pull wire. The transmission can be actuated by a driver operating the selector lever, via the sector gear arrangement and the push-pull wire.

However, there is a problem in the prior art vehicle automatic transmission selector apparatus in that a large backlash occurs during meshing of the teeth of the lever bracket and the select-link. Thus, the operability of the selector lever is deteriorated.

### SUMMARY OF THE INVENTION

It is, therefore, an object of the present invention to provide a selector apparatus for a vehicle automatic transmission which can suppress increased teeth backlash of the gear arrangement of the lever bracket and the select-link to improve operability of the selector lever.

According to the present invention, a selector apparatus comprises brackets to be secured on a body of a vehicle. A selector lever is pivotally supported on the brackets. A lever bracket is arranged at a base end of the selector lever and is formed with sector gear teeth. A selector-link, to actuate a transmission via a wire interposed between the selector-link and the transmission, is formed with sector gear teeth. The teeth mate with the sector gear teeth of the lever bracket. The selector-link is rotated by the pivotal motion of the selector lever. An urging mechanism urges the select-link toward the lever bracket so that the teeth of the select-link are brought close to the teeth of the lever bracket.

Preferably, a surface of the select-link, against which the urging mechanism abuts, is formed with wavy irregularities each corresponding to one position of the selector lever.

According to the invention, since the urging mechanism usually urges the select-link toward the lever bracket, so that the teeth of the select-link are brought close to the teeth of the lever bracket, it is possible to suppress increased teeth backlash of the gear arrangement of the lever bracket and the select-link. Thus, this improves operability of the selector lever.

According the invention, since a surface of the select-link against which the urging means abuts is formed with wavy irregularities, each irregularity corresponding to one position of the selector lever, it is possible to provide a driver with a “shift-click feeling” during pivotal motion of the selector lever. Accordingly, this enables elimination of any additional mechanism that generate a “shift-click feeling” anywhere in the selector apparatus. Thus, this simplifies the structure of the selector apparatus.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a vehicle automatic transmission selector apparatus of a preferred embodiment of the present invention;

FIG. 2 is a side elevation view of the selector apparatus of FIG. 1, with one of brackets removed;

FIG. 3 is a cross-sectional view taken along a line III-III of FIG. 2;

FIG. 4 is a schematic view showing a positional relation among a lever bracket, a select-link and an urging mechanism of the selector apparatus.

FIG. 5 is a schematic view of a configuration of apertures through which the pivotal shaft of the select-link passes.

### DETAILED DESCRIPTION OF THE PREFERRED EMBODIMENTS

A preferred embodiment of the invention will be described with reference to accompanied drawings.

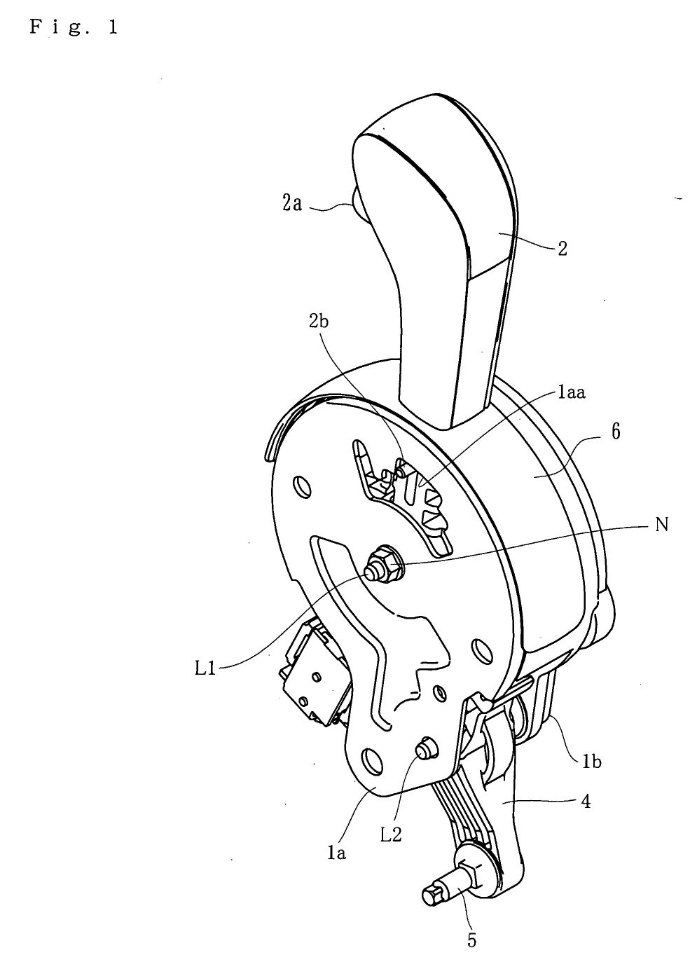

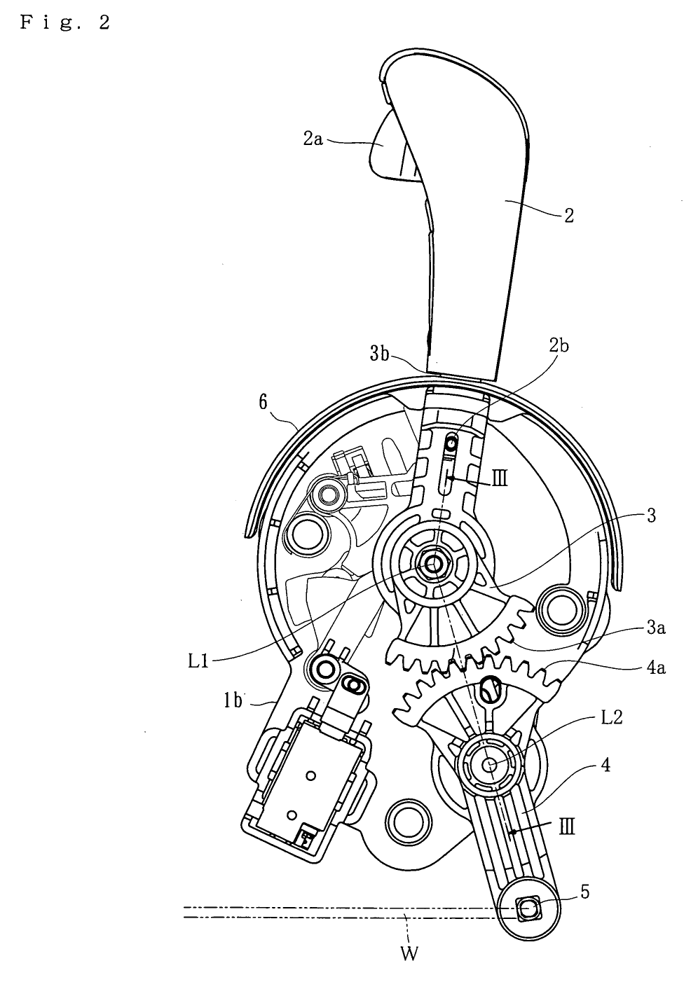

A vehicle selector apparatus automatic transmission of the present invention is a type which can select any driving position of an automatic transmission by transmitting the pivotal motion of a selector lever to a select-link via sector gears. As shown in FIG. 1, the selector apparatus includes brackets 1a and 1b to be secured on a body of vehicle. A selector lever 2 is pivotally supported within the brackets 1a and 1b. A lever bracket 3 (see FIG. 2) is mounted on the base end of the selector lever 2. A select-link 4 is associated with the selector lever 2.

The bracket 1a is formed from a metal sheet member and includes an erroneous operation preventing window 1aa. The window 1aa has a configuration according to positions of the selector lever 2 as well as apertures to enable passing therethrough of shafts L1 and L2, respectively, of the selector lever 2 and select link 4. The bracket 1a is combined with bracket 1b to form a box structure of the selector apparatus to be mounted on a body of the vehicle.

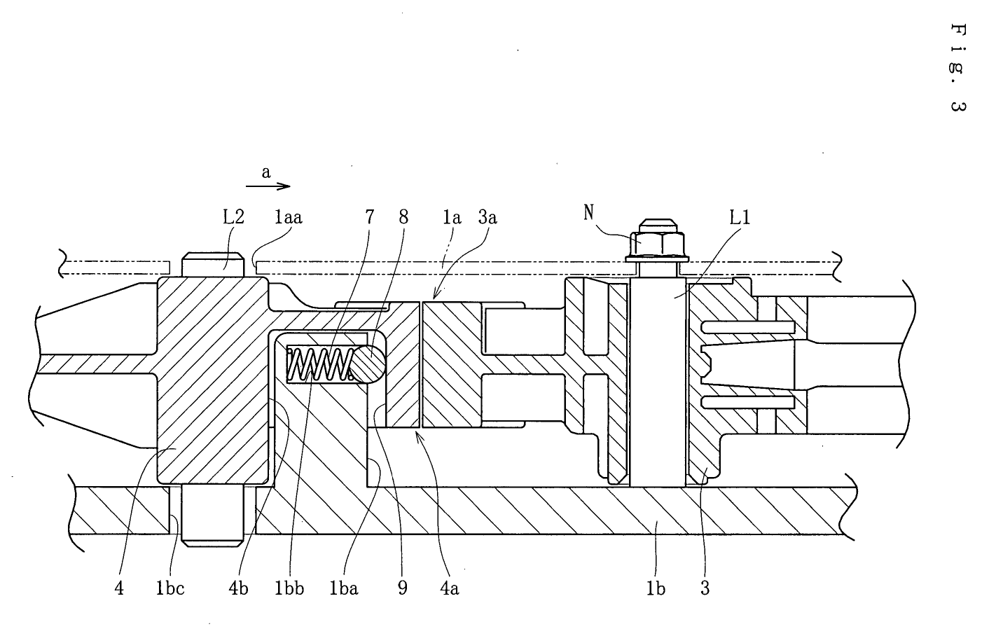

The bracket 1b has a secured shaft L1 and a floating shaft L2 to pivotally support the lever bracket 3 and the select-link 4, respectively. The bracket 1b is formed with a projected portion 1ba (see FIG. 3) which extends toward the bracket 1a (inside the selector apparatus). A bore 1bb, opened toward the lever bracket 3, is formed in the projected portion 1ba at a region near the end of the projected portion 1ba. The bore 1bb accommodates a detent spring 7 and a ball 8 which forms an urging mechanism. The end of the shaft L1 is formed with a screw thread. A nut N is fastened, after the lever bracket 3 and a select-link 4 etc. are assembled, onto the bracket 1b via the bracket 1a. On the contrary, the shaft L2 is integrated with the select-link 4 and is movable a slight distance.

The selector lever 2, pivotally operated by a driver of the vehicle has a push knob 2a (see FIG. 2) at its top end. The selector lever 2 is connected, at its bottom end, to the lever bracket 3, via a lever pipe (not shown). A rod lock pin (not shown) is arranged within the lever pipe. A lock pin 2b, engaging the erroneous operation preventing window 1aa, is passed through the rod lock pin and the lever bracket 3.

When the selector lever 2 is in the park position (P), the lock pin 2b engages the erroneous operation preventing window 1aa. The pin 2b prevents the selector lever 2 from being shifted toward the reverse position (R). In such a case, if the push knob 2a is pushed down, the rod lock pin 7 is moved downward, the locking of the lock pin 2b is released. Thus the selector lever 2 is allowed to pivot from the park position (P) to the reverse position (R).

Similarly, pivotal motion of the selector lever 2 is prevented unless the push knob 2a is pushed down in cases of shifting the selector lever 2 from the reverse position (R) to the parking position (P), from the neutral position (N) to the reverse position (R), and from the drive position (D) to the second speed position (2).

The lever bracket 3 is arranged at the bottom end (base end) of the selector lever 2. The lever bracket 3 is able to pivot around the shaft L1 together with the selector lever 2. The lever bracket 3 is also formed with teeth 3a of a sector gear at a position lower than the shaft L1.

Similarly to the lever bracket 3, the select-link 4 is also pivotable around the shaft L2. Also, the select-link 4 is formed, at its top end, with teeth 4a of a sector gear. The teeth 4a mate with the teeth 3a of sector gear of the lever bracket 3. The bottom end of the select-link 4 includes an end bolt 5 to connect a push-pull wire W (see FIG. 2).

The pivotal motion of the selector lever 2 is transmitted to the select-link 4 via the sector gears. Thus, the automatic transmission is operated via the push-pull wire W. In this case, the direction of the pivotal motion of the selector lever 2 is the same as the moving direction of wire W. A reference numeral 6 in FIGS. 1 and 2 denotes a selector lever cover. The cover 6 moves together with the selector lever 2, which is passed through an aperture 6a formed substantially at the center of the cover 6a.

In the selector apparatus of the present invention, the select-link 4 is formed with a recess 4b to accommodate the projected portion 1b which extends from the bracket 1b, as best shown in FIG. 3. In addition, the inner surface of the recess 4b, at a side near the lever bracket 3, is formed with wavy irregularities 9. Each irregularity corresponds to one position of the selector lever 2. The ball 8, urged by the detent spring 7, always abuts and urges the wavy irregular surface 9.

The ball 8 fits into any one recessed portion of the wavy irregularities 9 when the selector lever 2 is positioned at any one of the positions (e.g. parking, reverse or drive position etc.). The ball 8 firmly holds the selector lever 2 at the selected position. During shifting of the selector lever 2, from one position to another adjacent position, the ball 8 rides over the peak of one wavy irregular portion 9 and then falls down the valley. This provides a driver with a “shift-click feeling” during the operation of the selector lever 2.

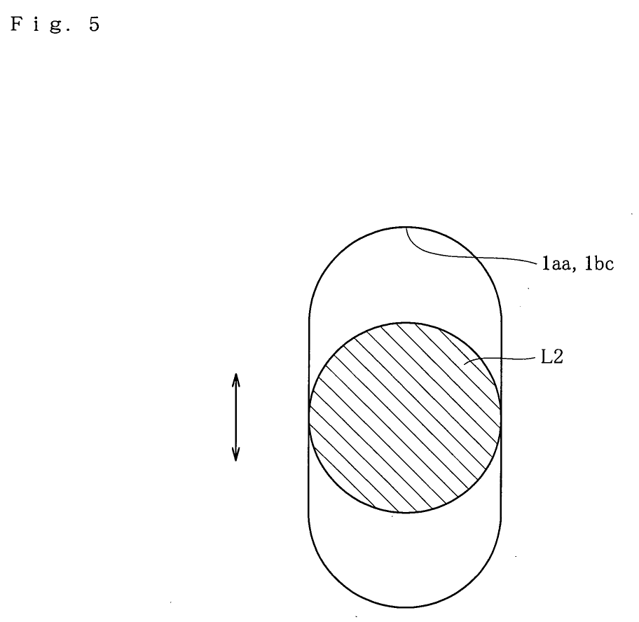

Apertures 1aa and 1bc, respectively, of the bracket 1a and 1b, through which the shaft L2 is passed, has an elongated configuration as shown in FIG. 5. The major axis of the elongated apertures 1aa and 1bc is set so that it lies on a line connecting the shafts L1 and L2. This enables the select-link 4 to be slightly displace toward the lever bracket 3, as shown by an arrow in FIG. 5.

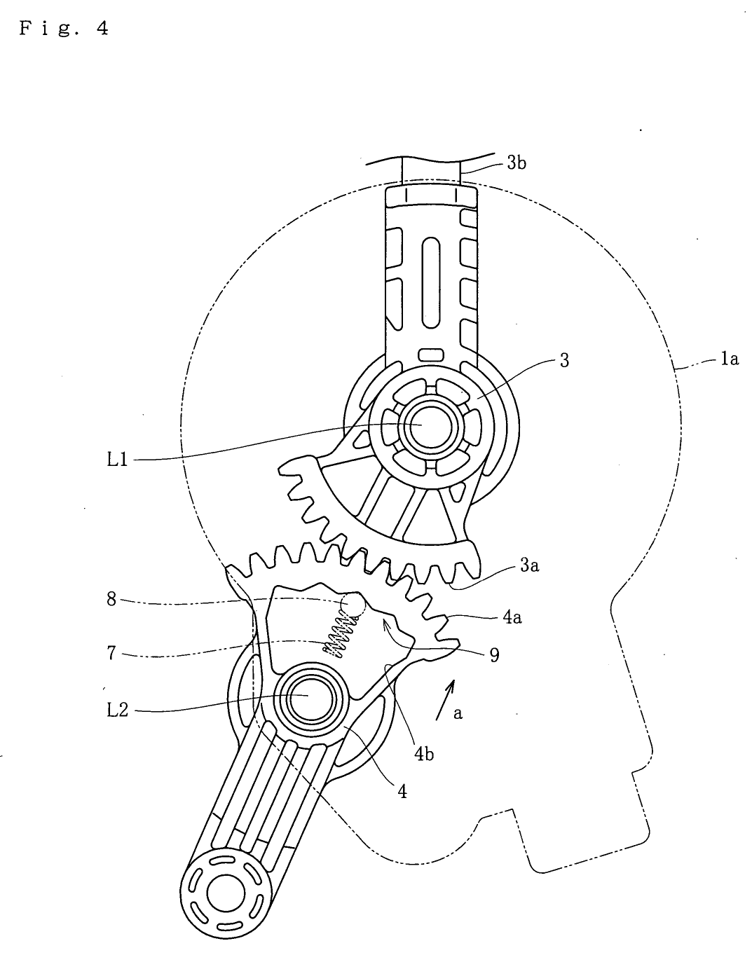

Thus, the select-link 4 is always urged toward the lever bracket 3, in a direction shown by an arrow “a” in FIGS. 3 and 4, by the ball 8 which, in turn, is urged by the detent spring 7 supported by the bracket 1b. Thus, the teeth 4a of the select-link 4 are urged toward the teeth 3a of the lever bracket 3.

The generation of a large backlash between the teeth 3a and 4a of the lever bracket 3 and the select-link is suppressed and the operability of the selector lever 2 can be improved. In addition, since a surface of the select-link 4, against which the ball 8 (urging mechanism) abuts, is formed with wavy irregularities 9. Each irregularity corresponds to one position of the selector lever 2. Thus, it is possible to provide a driver with a “shift-click feeling” during pivotal motion of the selector lever. Accordingly, this enables the elimination of any additional mechanism to generate the “shift-click feeling” anywhere in the selector apparatus. Thus, this simplifies the structure of the selector apparatus.

Although the present invention has been described with reference to the preferred embodiment, the present invention is not limited to this embodiment. For example, additional mechanisms to generate a “shift-click feeling” may be provided anywhere on the selector apparatus, as in the prior art. In this case, the surface in which the spring loaded ball 8 contacts may be changed to a smooth circular surface instead of the wavy irregularities 9.

Furthermore, other urging mechanism, such as elastic plastic member or rib, leaf spring, etc. extending from the projected portion 1ba to the wall of the recess 4b, may be used in place of the detent spring 7 and the ball 8. In addition, although it is shown in the preferred embodiment that the urging mechanism is provided on the bracket 1b, it may be possible to provide it on the bracket 1a.

In addition, it is possible, in place of providing the recess 4b, to provide a projection on the select-link 4 onto which the urging force is applied. In this case, it is preferable to arrange the projection near the teeth 4a so as to enable the urging force to be effectively transmitted.

The elongated apertures 1aa and 1bc, shown in the preferred embodiment, may be changed to round apertures. The round apertures have a diameter slightly larger than that of the shaft L2 so as to form a small gap therebetween.

For example, the present invention can be applied to an apparatus with brackets 1a and 1b or selector lever 2 of different configuration. Of course, the present invention can be also applied to a selector apparatus with any type of parking lock mechanism.

The present invention can be applied to any selector apparatus with a different outline configuration or additional function so long as it has the urging mechanism to urge the teeth of the select-link toward the teeth of the lever bracket.

The description of the invention is merely exemplary in nature and, thus, variations that do not depart from the gist of the invention are intended to be within the scope of the invention. Such variations are not to be regarded as a departure from the spirit and scope of the invention.

1. A vehicle automatic transmission selector apparatus comprising:
at least one bracket to be secured on a body of a vehicle;
a selector lever pivotally supported on the at least one bracket;
a lever bracket arranged at a base end of the selector lever and formed with sector gear teeth;
a selector-link, for actuating a transmission via a wire interposed between the selector-link and the transmission, formed with sector gear teeth mating with the sector gear teeth of the lever bracket and rotated by pivotal motion of the selector lever; and
an urging mechanism for urging the select-link toward the lever bracket so that the teeth of the select-link are brought close to the teeth of the lever bracket.

2. The vehicle automatic transmission selector apparatus of claim 1, wherein a surface of the select-link, against which the urging mechanism abuts, is formed with wavy irregularities each corresponding to one position of the selector lever.
